(19) United States
(12) Patent Application Publication
(10) Pub. No.: US 2021/0156163 A1
(43) Pub. Date: May 27, 2021

(54) Autonomous Cleaner

(71) Applicant: Poolelf Smart Technology Co., Ltd., Ningbo (CN)

(72) Inventors: Xin CAO, Ningbo (CN); Weijin LI, Ningbo (CN)

(21) Appl. No.: 16/908,651

(22) Filed: Jun. 22, 2020

(30) Foreign Application Priority Data
Nov. 21, 2019 (CN) 2019111457352
Nov. 21, 2019 (CN) 2019220191279

(51) Int. Cl. E04H 4/16; B08B 3/14; B08B 3/04; B08B 13/00

(52) U.S. Cl. CPC E04H 4/1654; B08B 3/14; B08B 1/002; B08B 13/00; B08B 3/041

(57) ABSTRACT

An autonomous cleaner includes a suction enhancer arrangement for mounting adjacent to an intake opening provided on a base surface of the autonomous cleaner. The suction enhancer arrangement includes at least one barrier member having a mounting end side mounted to the base surface and a free end side downwardly extended from the base surface. The at least one barrier member is made of elastic material and arranged to be positioned and extended between two side portions of the base surface and adjacent to the intake opening, defining a space below the base surface and the at least one barrier member as an intaking space, such that a flow of liquid to be sucked into the intake opening is speed up in the intaking space to enhance a suction effect thereat.

### CROSS REFERENCE OF RELATED APPLICATION

This application is a non-provisional application that claims the benefit of priority under 35 U.S.C. § 119 to Chinese application, application number CN2019111457352, filed Nov. 21, 2019, and Chinese application, application number CN2019220191279, filed Nov. 21, 2019, which are incorporated herewith by references in their entities.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to robotic pool cleaner, and more particularly to an autonomous cleaner which can enhance the suction and cleaning capability thereof with a suction enhancer arrangement.

### Description of Related Arts

In other to clean a ground surface under water, there are conventional electrical automatic pool cleaner driven to move under water to clean the floor surface of a water pool, swimming pool, pond, or the like. The conventional pool cleaners comprises a vacuum unit for pumping liquid, such as water, in the pool or pond as well as trash such as leaves, sands dust, dirt, and etc. in the liquid around an intake opening into a filtering device where trash and particles, such as leaves, sands, dust and dirt, are filtered out and collected in a container and the filtered clean liquid is pumped back to the pool or pond. After activated, the conventional pool cleaner moves around automatically underwater in the pool or pond to collect trash, dust and/or rubbish along a moving path.

The vacuum power of the conventional underwater cleaner is the most essential factor for its cleaning performance. Accordingly, the manufacturers have to equip a more powerful motor to generate more suction power for collecting more and bigger trash and particles, rendering the conventional underwater cleaner having a bulky size and heavy weight and being more expensive. Furthermore, in order to enhance the power of collecting while moving, a high-power vacuum unit would be equipped in the conventional cleaner that consumes more power and external power is required. Since wireless electrical device is highly demanded in the market, a relatively big rechargeable battery unit is required to be contained in the conventional pool cleaner for longer operation time to at least clean the entire floor surface of the pool or pond. However, bigger and heavier body of the conventional pool cleaner not only is more costly but also requires more power supply too.

Other designers or engineers focus on the cleaning rate or cleaning coverage of the cleaner so as to provide a more effective cleaning ability. Accordingly, a popular development of conventional pool cleaner is aimed on developing a smarter cleaner that can effectively complete the cleaning with an optimized path. However, this kind of development costs much on programing software and mechanical hardware. To low cost structural configuration, there are mechanical or algorithmic limitations.

All manufacturers have a difficulty to overcome for wireless pool cleaner. That is the power supply is not only for driving the vacuum unit for cleaning purpose but also for driving the wheels of the cleaner to move around the floor surface of the pool or pond, so that how to design a wireless rechargeable pool cleaner which has greater suction power and higher trash collection ability with simple and relatively lower cost structure and is smaller in size and lighter in weight becomes a desire to most of the users.

A lot of users compliant to the conventional pool cleaner that, although it takes much time and power to ensure the pool cleaner to completely moving all around the floor surface of the pool, some trash and particles are still remained in the swimming pool. In other words, common household pool cleaner generally fails to effectively clean away the trash and particles in the swimming pool even though time and power are consumed.

### SUMMARY OF THE PRESENT INVENTION

The invention is advantageous in that it provides an autonomous cleaner which comprises a suction enhancer arrangement installed to a cleaner housing thereof, that can enhance the suction and cleaning capability of a power assembly thereof.

Another advantage of the invention is to provide an autonomous cleaner which has high collecting effect to clean the floor of a containing environment such as pool or pond with relatively low cost and simple structure.

Another advantage of the invention is to provide an autonomous cleaner, which is adapted to serve on the floor surface of a containing environment such as house or pool to purify liquid in the containing environment effectively.

Another advantage of the invention is to provide a suction enhancer arrangement which is adapted to be installed to an autonomous cleaner, such as a pool cleaner, for cleaning a floor surface of a containing environment, such as swimming pool, liquid pond, water container, or the like, while containing liquid or water therein.

Another advantage of the invention is to provide a suction enhancer arrangement which is adapted for equipping with an autonomous cleaner without modifying its operation program and/or mechanical structure, including its vacuum unit, power assembly, and filtering device so as to enable the manufacture to enhance the suction and cleaning ability of the autonomous cleaner without increasing the selling price thereof.

Another advantage of the invention is to provide an autonomous cleaner having the usual mechanical structure and electrical configuration but providing enhanced suction and cleaning ability by simply installing a suction enhancer arrangement to the outer casing of the cleaner housing thereof with respect to the intake opening of the cleaner housing of the autonomous cleaner.

Another advantage of the invention is to provide an autonomous cleaner which is easy to manufacture and maintenance.

Another advantage of the invention is to provide an autonomous cleaner which can enhance its collecting efficiency for better cleaning result without increasing the power consumption.

Another advantage of the invention is to provide an autonomous cleaner which can speed up the water intaking speed for better cleaning effect.

Another advantage of the invention is to provide an autonomous cleaner which can optimize air or water flow and suction power without producing extra operation noise or requiring extra horsepower.

Additional advantages and features of the invention will become apparent from the description which follows, and may be realized by means of the instrumentalities and combinations particular point out in the appended claims.

According to the present invention, the foregoing and other objects and advantages are attained, in one aspect, by an autonomous cleaner for cleaning away trash on a floor surface under liquid, comprising:

a cleaner housing having a base surface, a receiving cavity therein, an intake opening provided on the base surface, and a discharge outlet communicated with the receiving cavity and the intake opening;

a moving unit, arranged to the cleaner housing, adapted for moving on the floor surface and supporting the base surface above the floor surface for a predetermined intaking distance;

a power assembly arranged to drive the moving unit to move in a path on the floor surface and provide a suction effect at the intake opening of the cleaner housing for intaking liquid and any trash within a collection space defined between the base surface of the cleaner housing and the floor surface where the cleaner housing moving thereon with a flow of liquid;

a filtering device installed in the receiving cavity of the cleaner housing, such that the trash in the liquid sucked through the intake opening is filtered and collected by the filtering device and discharged from the discharge outlet; and

a suction enhancer arrangement provided adjacent to the intake opening of the cleaner housing to define an intaking space between the intake opening and the floor surface, such that the flow of liquid to be sucked into the intake opening is speed up in the intaking space to enhance the suction effect.

In another aspect, the present invention provides a suction enhancer arrangement for an autonomous pool cleaner which comprises a cleaner housing having a base surface and an intake opening provided on the base surface, a moving unit arranged to the cleaner housing, a power assembly arranged to drive the moving unit to move on a floor surface of a containing environment such as a pool and provide a suction force at a collection space defined around the intake opening, and a filtering device arranged in the cleaner housing for filtering and collecting trash in a liquid of the containing environment sucked in through the intake opening before discharging the filtered liquid back to the containing environment through the discharge outlet, wherein the suction enhancer arrangement is provided adjacent to the intake opening of the cleaner housing to define an intaking space between the intake opening and the floor surface where the cleaner housing moving thereon, such that the flow of liquid to be sucked into the intake opening is speed up in the intaking space to enhance a suction effect thereat.

In one embodiment, the moving unit comprises at least two moving wheels rotatably mounted to both sides of the cleaner housing respectively and being driven by the power assembly to rotate for moving the cleaner housing on the floor surface while the base surface is supported by the moving wheels above the floor surface, wherein a portion of each of the wheels is extended below the base surface to define the predetermined intaking distance between the base surface and the floor surface, that is a distance between bottom edges of the moving wheels and the base surface of the cleaner housing.

In one embodiment, the suction enhancer arrangement comprises at least one barrier member provided adjacent to the intake opening and protruded from the base surface with a width smaller than the predetermined intaking distance between the base surface and the floor surface where the cleaner housing being driven to move thereon in such a manner that an intaking clearance is formed between a free end side of the barrier member and the floor surface where the autonomous cleaner moving thereon, wherein the intaking space includes at least the space between the intake opening and the barrier member. In other words, the at least one barrier member divides the collection space into the intaking space between the intake opening and the at least one barrier member and an outer space surrounding the at least one barrier member. A flow of liquid having a first flowing speed will be produced in the collection space according to the suction effect generated by the power assembly to drive liquid with any trash therein to flow into the intake opening. However, the flow of liquid will be speed up while passing the narrowed intaking clearance that substantially increases the suction force within the intaking space to suck liquid and any trash in the intaking space to flow into the intake opening with a second flowing speed which is faster than the first flowing speed.

In one embodiment, a pair of elongated barrier members each having a mounting end side configured to be mounted on the base surface and a free end side downwardly extended from the base surface, such that the two barrier members are positioned and extended between two side portions of the base surface of the cleaner housing and the intake opening is positioned between the two barrier members, defining a space below the base surface and between the two barrier members as the intaking space.

In one embodiment, the barrier member is made of elastic material that the barrier member is able to bend toward the base surface while a pushing force is exerted on the barrier member towards the intake opening. Accordingly, when the barrier member of the moving autonomous cleaner meets a trash having a size larger than the intaking clearance, the trash experienced the suction force generated by the power assembly in the collection space will push the barrier member to bend towards the base surface to enlarge the intaking clearance to enable the trash to position in the intaking space and flow into the intake opening.

In one embodiment, the autonomous cleaner further comprises a rotatable brush rotatably arranged on the bottom of the cleaner housing and positioned in front of the suction enhancer arrangement, wherein the rotatable brush is driven to rotate towards the barrier member by the power assembly for sweeping and collecting trash on the floor surface.

In one embodiment, the barrier member is mounted on the base surface of the cleaner housing by inserting and engaging the mounting end side of the barrier member into the base surface. Preferably, the barrier member is detachably engaged with the bottom of the cleaner housing.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a top perspective view of an autonomous cleaner according to a first preferred embodiment of the present invention.

FIG. 2 is a bottom perspective view of the autonomous cleaner according to above preferred embodiment of the present invention.

FIG. 3 is a partially exploded view of the autonomous cleaner according to above preferred embodiment of the present invention.

FIG. 4 is a side view illustrating the autonomous cleaner on a floor surface of a containing environment such as pool or the like to be cleaned by the autonomous cleaner according to above preferred embodiment of the present invention, wherein an enlarged view of the pair of barrier members is provided to illustrate the collection space, the intaking space, and the intaking clearance defined among the barrier members, the floor surface and the base surface of the autonomous cleaner.

FIG. 5 is a schematic view illustrating an operational cleaning path of the autonomous cleaner according to above preferred embodiment of the present invention.

FIG. 6 is partially exploded perspective view, illustrating the mounting configuration of the barrier members and the cleaner housing of the autonomous cleaner according to above preferred embodiment of the present invention.

FIG. 7 is a sectional view of the autonomous cleaner according to above preferred embodiment of the present invention.

FIG. 8 is a bottom perspective view of the autonomous cleaner according to above preferred embodiment of the present invention, wherein an enlarged sectional view is provided to illustrate the engagement and movement of the barrier member.

FIG. 9 is a bottom perspective view of the autonomous cleaner according to a second preferred embodiment of the present invention.

FIG. 10 is a bottom perspective view of the autonomous cleaner according to a third preferred embodiment of the present invention.

FIG. 11A to 11C are partial sectional views of three alternative modes of the barrier member of the autonomous cleaner according to above preferred embodiments of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

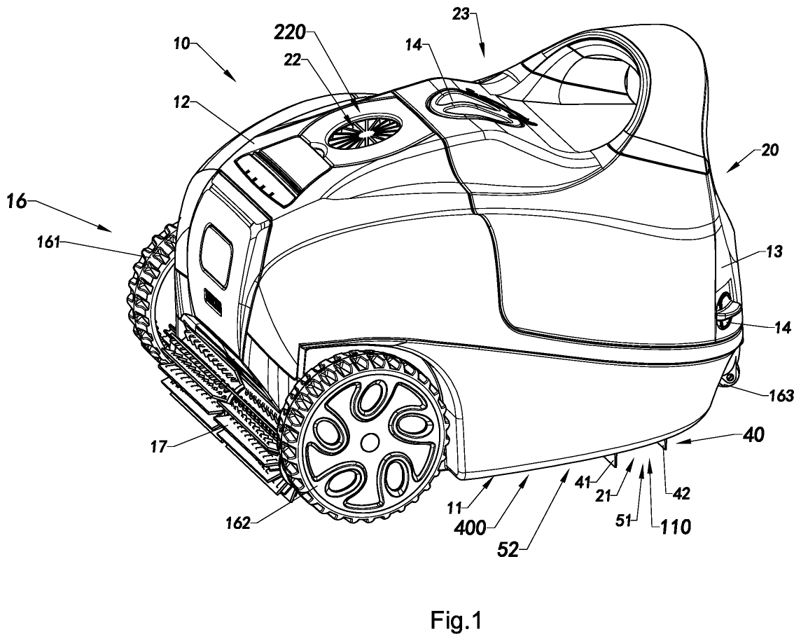

The present invention provides an autonomous cleaner adapted to be served on the floor of house, pool, container, or the like while containing liquid or water, as shown in FIGS. 1 to 11C. The autonomous cleaner is preferably electrically powered to move around on a floor surface of a containing environment for cleaning purposes through suction vacuuming, brushing, sweeping, and etc.

Please referring to FIG. 1 to FIG. 5, the autonomous cleaner comprises a cleaner housing 10, a filtering device 20 installed therein and a power assembly 30 providing driving power for the cleaner housing 10 traveling along a cleaning path 91 over a floor surface 90 of a containing environment, such as house, pool, container, or the like, containing liquid therein or on the floor surface 90 to be cleaned.

The cleaner housing 10 has a base surface 11 at a bottom thereof, a receiving cavity 15 therein, a moving unit 16 arranged thereto for moving on the floor surface 90 and supporting the base surface 11 above the floor surface 90 for a predetermined intaking distance H2, an intake opening 21 at the base surface 11, and a discharge outlet 22 communicated with the receiving cavity 15 and the intake opening 21.

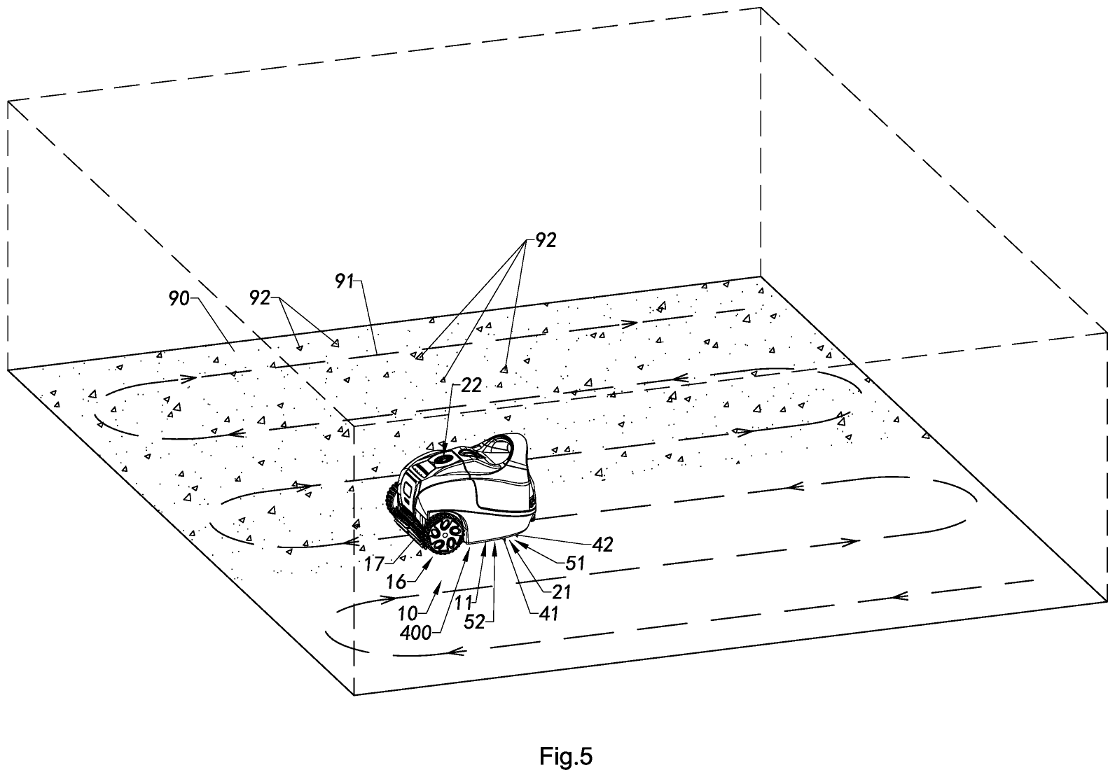

The power assembly 30 further comprises a pump 31 which is electrically powered to provide suction force and effect at the intake opening 21 of the cleaner housing 10 for intaking liquid and any trash within a collection space 400 defined between the base surface 11 of the cleaner housing 10 and the floor surface 90 where the cleaner housing 10 moving thereon with a predetermined flow of liquid on the floor surface 90 to collect trash 92, such as dirt, sludges, muds, sands, leaves, sediments, and other particles in the liquid or water in the containing environment. The trash 92 are tended to be filtered and collected inside the filtering device 20 as shown in FIG. 5.

The moving unit 16 comprises at least two wheels 161, 162 which are rotatably mounted to both sides of a front portion of the cleaner housing 10 respectively and driven to rotate by the activated power assembly 30 for supporting the cleaner housing 10 on the floor surface 90 to move towards a moving direction. The moving unit 16 may further comprise a free wheel 163 rotatably mounted to a rear portion of the cleaner housing 10 for supporting the base surface 11 above the floor surface 90 to define the collection space 400 between the base surface 11 and the floor surface 90.

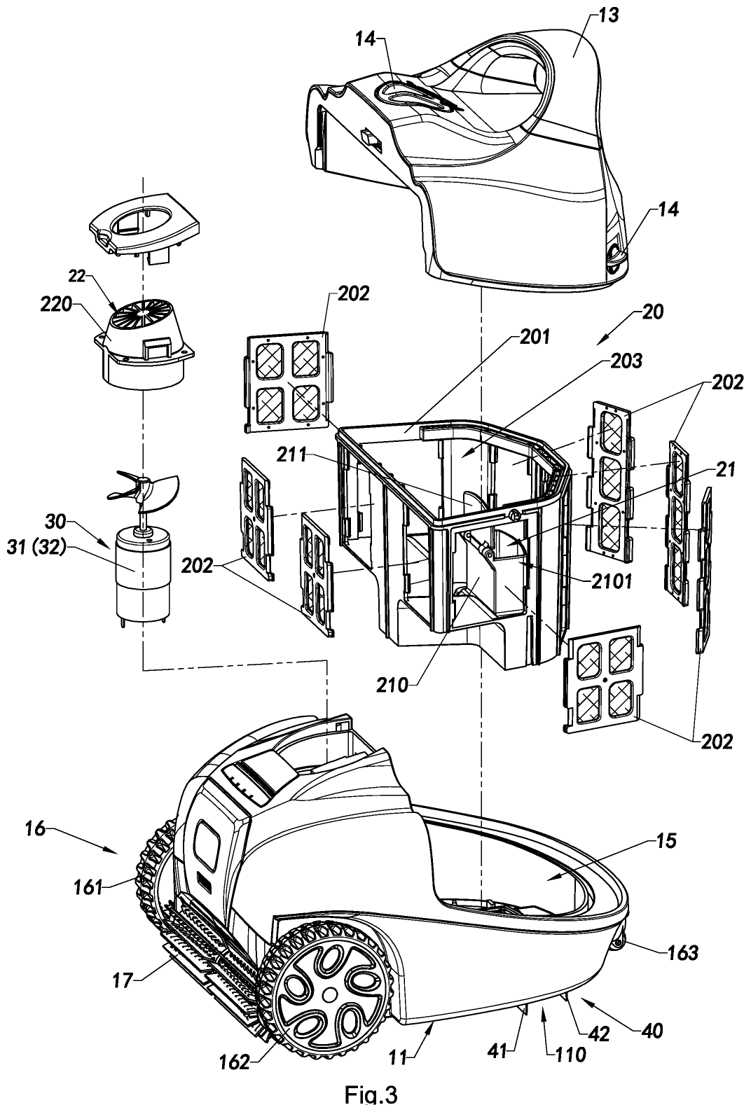

The cleaner housing 10 further comprises a base body 12, a detachable cover 13 and a fastener 14 arranged to fasten the detachable cover 13 to the base body 12. The wheels 161, 162 are rotatably mounted to a left side and a right side of the base body 12 to support the cleaner housing 10 to move on the floor surface 90. The detachable cover 13 is detachably connected with the base body 12 by the fastener 14 to form the receiving cavity 15 inside the base body 12 and the connecting detachable cover 13 to receive the filtering device 20 therein, so that the filtering device 20 is secured within the cleaner housing 10 while moving along the cleaning path 91. The filtering device 20 can be removed from the base body 12 when the fastener 14 is unlocked and the detachable cover 13 is detached from the base body 12, as shown in FIG. 3.

According to the preferred embodiment of the present invention, referring to FIG. 3, the filtering device 20 comprises a filtering container 201 and a plurality of filtering nets 202 mounted around the filtering container 201 to define a filtering chamber 203 therein, wherein the filtering chamber 203 is communicated with the receiving cavity 15 through the filtering nets 202.

According to the preferred embodiment, the intake opening 21 of the filtering device 20 is formed at the filtering container 201 which further comprises an opening door 211 that normally covers the intake opening 21 and is opened when liquid is sucked towards the filtering container 201 by the pump 31, wherein the suction force drives the liquid to flow and open the opening door 211 so as to flow into the filtering container 201 through the intake opening 21.

According to the preferred embodiment, the filtering device 20 further comprises an outlet unit 220 mounted on top of the cleaner housing 10 and communicated with the receiving cavity 15 while the pump 31 is arranged to be mounted below the outlet unit 220, wherein the discharge outlet 22 of the filtering device 20 is formed in the outlet unit 220, such that the suction force provided by the activated pump 31 will pump the intaking liquid in the filtering container 201 to continuously flow into the receiving cavity 15 from the filtering chamber 203 through the filtering nets 202 and then discharge from the receiving cavity 15 to outside of the cleaner housing 10 through the discharge outlet 22 of an outlet unit 220, while the trash 92 in the liquid sucked into the filtering container 201 through the intake opening 21 is filtered and collected within the filtering chamber 203.

In other words, when the pump 31 is operated to suck in liquid on the floor surface 90, the liquid flowing is passing through the intake opening 21 into the receiving cavity 15 and is filtered by the filtering device 20. The trash 92 is trapped and retained in the filtering chamber 203 of the filtering device 20, and the filtered liquid is forced to flow through the discharge outlet 22 to discharge to the outside of the cleaner housing 10, so that the floor surface 90 is cleaned after the autonomous cleaner has been passed.

It is worth mentioning that the pump 31 can be alternatively embodied as a vacuum unit 32 to provide suction power when activated. The pump 31 or the vacuum unit 32 is preferably installed inside the base body 12 adjacent to the filtering device 20, so that the liquid or water is forced to flow across the filtering device 20 from the intake opening 21 formed at a bottom position (the base surface 11) of the cleaner housing 10 towards the discharge outlet 22 formed on top of the cleaner housing 10. In other words, the intake opening 21 is formed at a bottom position of the filtering device 20 facing the floor surface 90 while moving thereon while the discharge outlet 22 is formed on a top position of the filtering device 20, as shown in FIG. 1 to FIG. 3.

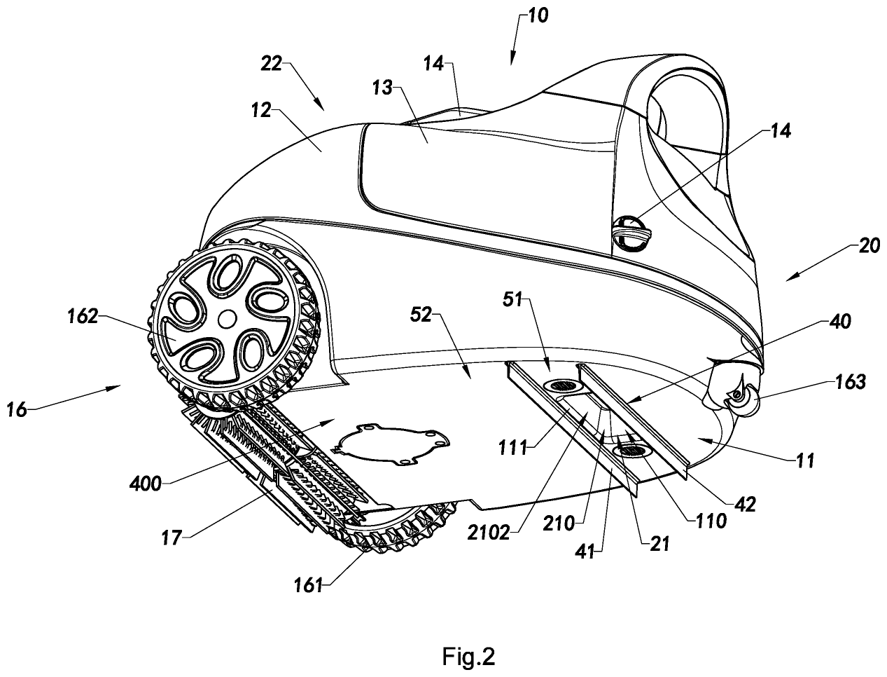

According to the preferred embodiment, referring FIGS. 2 and 3, the intake opening 21 is a tubular flowing channel 210 having an upper end 2101 extended into the filtering chamber 203 and configured to be closed by the opening door 211 and a lower end 2102 extended from the filtering container 201 to the base surface 11 of the cleaner housing 10 where an inlet opening 110 is formed in the base surface 11 to communicate with the intake opening 21 and enable liquid be sucked into the intake opening 21 through the inlet opening 110 right at the base surface 11.

The autonomous cleaner further comprises a suction enhancer arrangement 40 provided adjacent to the intake opening 21 of the cleaner housing 10 to define an intaking space 51 between the intake opening 21 and the floor surface 90 where the cleaner housing 10 moving thereon, such that the flow of liquid to be sucked into the intake opening 21 is speed up in the intaking space 51 to enhance the suction effect thereat.

According to the preferred embodiment, the autonomous cleaner further comprises a rotatable brush 17 rotatably mounted in front of the intake opening 21 on the base surface 11 in the moving direction.

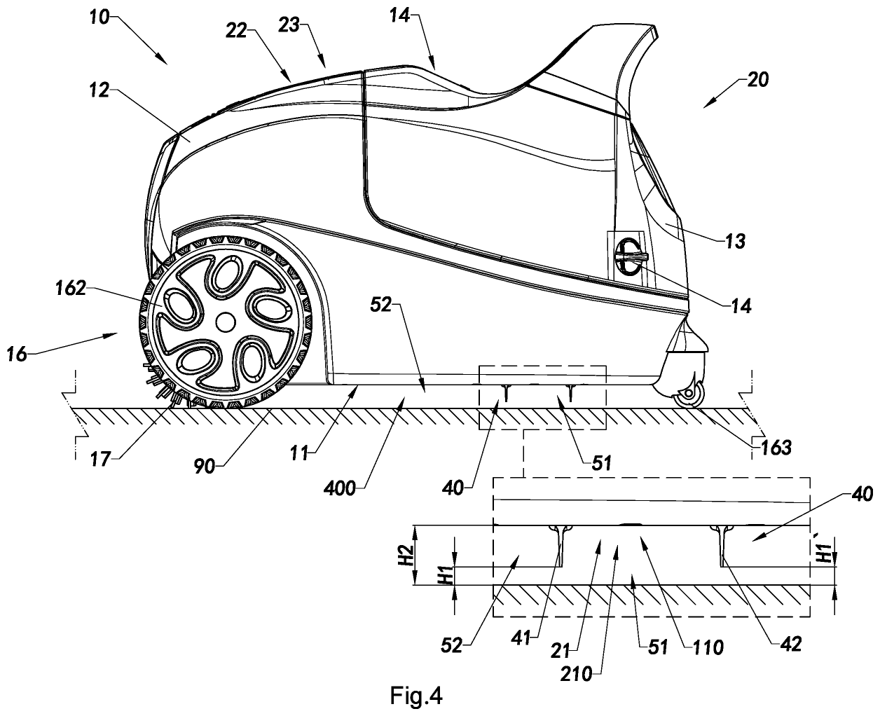

The suction enhancer arrangement 40 comprises one or more barrier members 41, 42 arranged on the bottom surface 11 of the cleaner housing 10. The one or more barrier members 41, 42 are provided adjacent to the intake opening 21 and protruded from the base surface 11 with a width smaller than the predetermined intaking distance H2 between the base surface 11 and the floor surface 90, as shown in FIG. 4, where the cleaner housing 10 being driven to move thereon, such that an intaking clearance H1 is formed between a free end side 43 of the barrier members 41, 42 and the floor surface 90 where the autonomous cleaner moving thereon, wherein the intaking space 51 includes at least a space between the intake opening 21 and the barrier members 41, 42. In other words, the barrier members 41, 42 divide the collection space 400 into the intaking space 51 between the intake opening 21 and the barrier members 41, 42 and an outer space 52 surrounding the barrier members 41, 42. A flow of liquid having a first flowing speed will be produced in the collection space 400 according to the suction effect generated by the power assembly 30 to drive liquid with any trash 92 therein to flow into the intake opening 21. However, the flow of liquid will be speed up while passing the narrowed intaking clearance H1 that substantially increase the suction force within the intaking space 51 to suck the liquid and the trash 92 in the intaking space 51 to flow into the intake opening 21 with a second flowing speed which is faster than the first flowing speed.

The rotatable brush 17 is rotatable mounted in front of the suction enhancer arrangement 40. According to the preferred embodiment, as shown in FIGS. 1-3, the rotatable brush 17 is positioned at the front end of cleaner housing 10 between the pair of wheels 161, 162 and driven by the power assembly 30 to rotate in a direction towards the rear end of the cleaner housing 10 so as to drive the autonomous cleaner to move in the moving direction, as shown in FIGS. 4 and 5.

When the power assembly 30 is activated, the rotatable brush 17 is rotated to sweep and bring the trash 92 towards the barrier members 41, 42 and reaching the collection space 400, where the suction force generated will suck the trash 92 with the liquid into the intake opening 21. In addition, while the autonomous cleaner is also moving forwards, the trash 92 at the intaking space 51 where the suction effect is enhanced and the liquid flowing speed is increased for effectively sucking into the intake opening 21 and being filtered by the filtering device 20 and collected in the filtering container 201.

It is worth mentioning that at least one of the barrier members 41 is mounted between the rotatable brush 17 (the front end of the cleaner housing 10) and the intake opening 21, wherein the front barrier member 41 has a length slightly shorter than or equal to a corresponding width of the base surface 11 and is positioned adjacent to the front side of the inlet opening 110 where the lower end of the flowing channel 210 of the intake opening 21 is integrally connected therewith, so as to divide the collection space 400 into the intaking space 51 behind the front barrier member 41 and outer space 52 in front of the front barrier member 41.

According to the preferred embodiment, the one or more barrier members 41, 42 are provided around the intake opening 21 that, in particular, does lengthen the flowing channel 210 to just like forming an enlarged lower end portion for the flowing channel 210. In other words, the intaking space 51 would be functioned as an enlarged intaking end portion of the flowing channel 210 of the intake opening 21, so that the intake opening 21 substantially has a size much smaller than the size of the intaking space 51 relatively that produces a nozzle effect at the intake opening 21 (the flowing channel 210) and instantly increases the flowing speed of the liquid into the intake opening 21, so as to increase the suction effect in the flowing channel 210 and the intaking space 51. Referring to FIG. 2, according to the preferred embodiment of the present invention, the two barrier members 41, 42 are provided, each of which is an elongated strip made of elastic material, such as rubber, plastic or the like, having the thinner free end side 43 and the thicker mounting end side 44 configured to be mounted on the base surface 11, such that the two barrier members 41, 42 are extended between two side portions of the base surface 11 of the cleaner housing respectively and positioned adjacent to the front side and rear side of the inlet opening 110 respectively in parallel manner, where the lower end of the flowing channel 210 of the intake opening 21 is integrally connected therewith, defining a space below the base surface 11 and between the two barrier members 41, 42 as the intaking space 51.

Each of the barrier members 41, 42 may have a triangular cross section that the thickness of the mounting end side 44 is wider than the free end side 43 while the free end side 43 of the barrier member 41, 42 is as thin as a blade like, so that the barrier member is able to bend toward the base surface 11 while a pushing force is exerted on the barrier member 41, 42 towards the intake opening 21. Accordingly, when the barrier member 41, 42 of the moving autonomous cleaner meets a trash 92 having a size larger than the intaking clearance H1, the trash 92 experienced the suction force generated by the power assembly 30 in the collection space 400 will push the barrier member 41, 42 to bend towards the base surface 11 to enlarge the intaking clearance H1 to enable the trash 92 to position in the intaking space 51 and flow into the intake opening 21.

In this embodiment of the present invention, the barrier members 41, 42 are mounted in lines near the intake opening 21 in front and rear according to the moving direction. Furthermore, since the cleaner housing 10 has the inlet opening 110 in the base surface 11 with respect to the intake opening 21, preferably, the cleaner housing 10 comprises an annular positioner 111 defining the inlet opening 110 adapted to integrally connect and align the lower end 2102 of the flowing channel 210 of the intake opening 21 with the inlet opening 110 and provide a curved guiding annular edge for guiding the flow of liquid into the intake opening 21.

Accordingly, the intake opening 21 of the cleaner housing 10 is adapted to be formed beyond the annular positioner 111 inside the cleaner housing 10. After the liquid with the trash 92 being sucked and flowing into the filtering chamber 203 of the filtering container 201, the opening door 211 is configured to normally close the intake opening 21 to prevent the trash 92 back flowing out through the intake opening 21. It will be understood that the barrier members 41, 42 can also in circular shape according to the shape of the intake opening 21 or the inlet opening 110 of the cleaner housing 10.

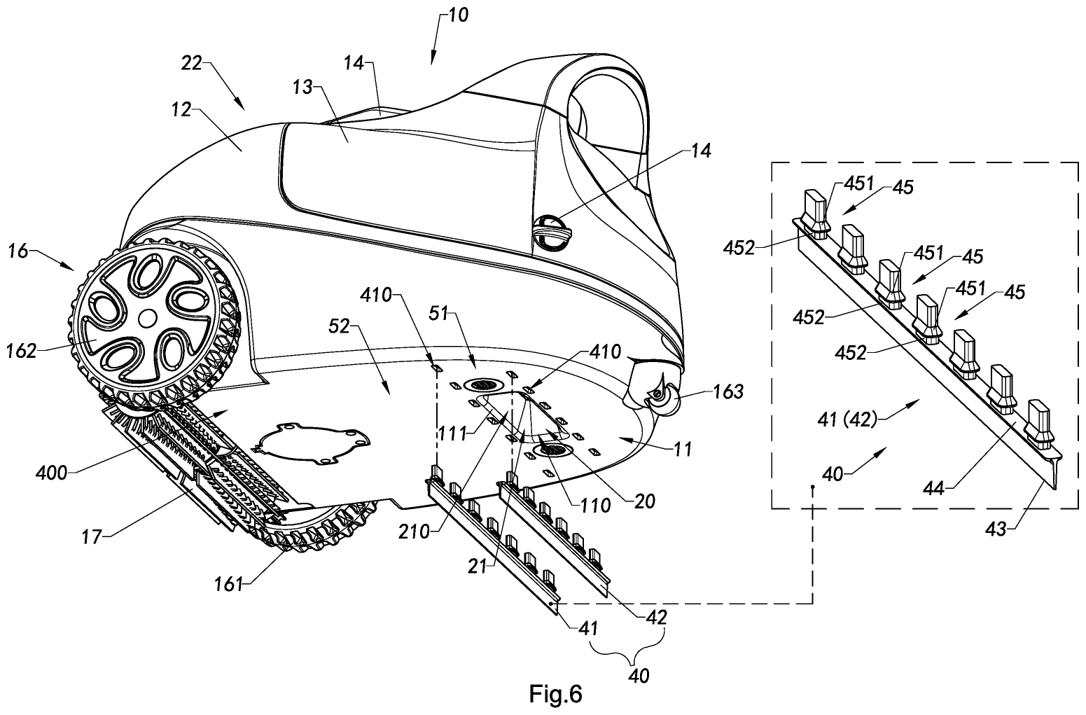

Furthermore, as shown in FIGS. 6 to 8, the barrier members 41, 42 according to the preferred embodiment are fastened to the bottom surface 11 of the base body 12 of the cleaner housing 10. The free end side 43 of the barrier members 41, 42 is extended from the bottom surface 11 of the cleaner housing 10 and to closely to the floor surface 90 to define the intaking clearance H1 between the free end side 43 and the floor surface 90. The extending width of each of the barrier members 41, 42 is slightly short than the portions of wheels 161, 162 extending below the bottom surface 11 of the cleaner housing 10, so that the free end sides 43 of the barrier members 41, 42 are arranged closely to the floor surface 90 when the wheels 161, 162 are driven to rotate to move forward on the floor surface 90.

Since the thickness of each of the barrier members 41, 42 is reduced gradually to the free end side 43 thereof so that at least the free end side 43 of each of the barrier members 41, 42 has an elasticity enabling it to be bent and curved towards the intake opening 21.

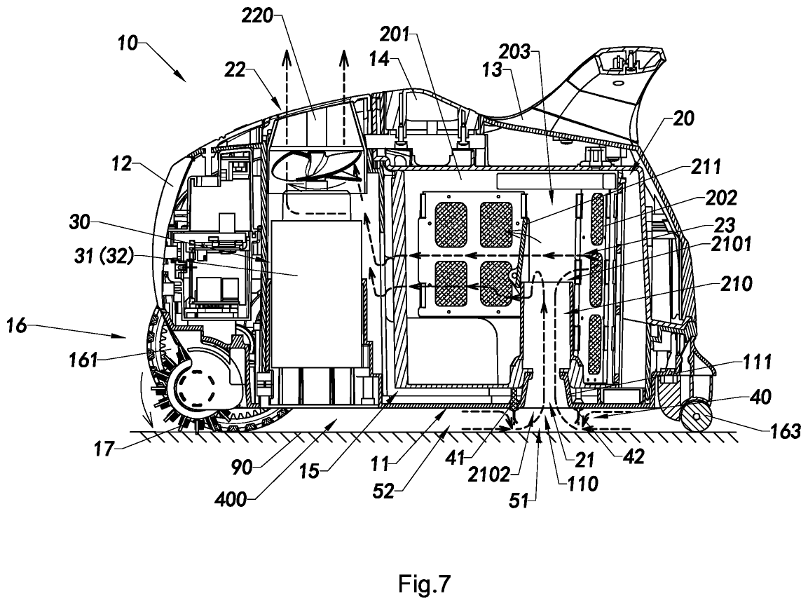

When the autonomous cleaner is moving on the floor surface 90, the power assembly 30 provides suction power for the filtering device 20. While the wheels 161, 162 are driven to rotate to drive the autonomous cleaner to move forwards, the rotatable brush 17 is rotated either by the power assembly 30 or due to the friction between the rotatable brush 17 and the floor surface 90, as shown in FIG. 4, so as to block trash 92 having a size larger than the predetermined intaking distance H2 and to sweep trash 92 having a size equal to or smaller than the predetermined intaking distance H2 in the liquid flowing towards the collection space 400 under the base surface 11, wherein the trash 92 having a size smaller than the intaking clearance H1 will be further sucked to the intaking space 51 defined between the barrier members 41, 42 while the autonomous cleaner keep moving forwards, and that the trash 92 having a size larger than the intaking clearance H1 as well as the trash 92 floating in the liquid within the outer space 52 of the collection space 400 will exert pushing forces against the front barrier member 41, while the autonomous cleaner moving forwards, to bend the free end side 43 thereof towards the intake opening 21 and broaden the intaking clearance H1, as shown in FIGS. 4 and 7, to let the trash 92 reaching the intaking space 51 and being sucked into the intake opening 21.

In other words, as shown in FIGS. 4 and 7, the barrier members 41, 42 are downwardly extended closely with the floor surface 90, wherein the liquid in the collection space 400 will be accelerated to reach the position of the barrier members 41, 42, and the trash 92 will be pushed by the increased force at the intaking space 51 between the barrier members 41, 42. Since the intaking clearance H1 is narrower than the predetermined intaking distance H2 below the bottom surface 11 of the cleaner housing 10, the trash 92 are under greater suction force and effect that have more chances to be sucked into the filtering device 20 with the liquid. Once the trashes 92 are collected into the intake opening 21 of the filtering device 20, the trashes 92 are retained and collected inside the filtering container 201 of the filtering device 20 and the liquid will keep flowing towards the discharge outlet 22 from the filtering device 20 to be discharged from the discharge outlet 22.

It is worth mentioning that the barrier members 41, 42 are stationary arrangement that does not require any power from the power assembly 30. So, the power assembly 30 can merely provide power to the pump 31 or the vacuum unit 32, the wheels 161, 162 and the rotatable brush 17 that just likes the conventional cleaner. However, the autonomous cleaner of the present invention provides greater suction force and effect for filtering the liquid and removing the trash 92, resulting in speeding up the filtration of the filtering device 20 without the need of higher output of the pump 31 or the power assembly 30.

The barrier members 41, 42 are easily to be mounted on the base surface 11 of the base body 12. In one embodiment, the barrier members 41, 42 can simply be adhered on the base surface 11, such as using adhesive to integrally adhere the mounting end side 44 on the base surface 11 such that the free end side 43 of the barrier member 41, 42 is perpendicularly protruded from the base surface 11. In order to be precisely mounting the barrier members 41, 42 in position, a pair of parallel indented grooves (not shown) can be provided adjacent to the front side and rear side of the inlet opening 110 so that the mounting end sides 44 of the barrier members 41, 42 can be fittingly adhered to the indented grooves.

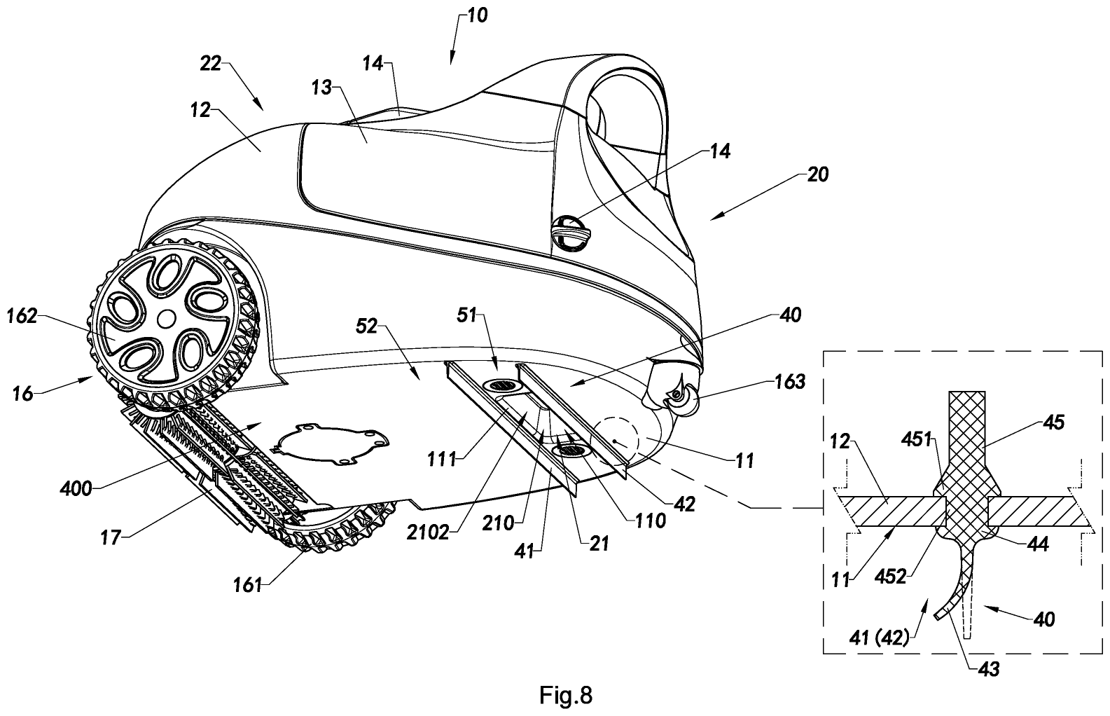

According to the preferred embodiment of the present invention, as shown in FIGS. 6 and 8, a plurality of engagement holes 410 is formed along the front side and rear side of the inlet opening 110 so as to provide two roles of engagement holes 410 for engaging with the mounting end sides 44 of the pair of barrier members 41, 42 respectively. Correspondingly, as shown in FIG. 6, each of the barrier members 41, 42 further comprises a plurality of engagement plugs 45 provided at the enlarged mounting end side 44 thereof and configured to be inserted into the engagement holes 410 respectively. Referring to FIG. 8, each of the engagement plugs 45 comprises at least an engaging stopper 451 and a mounting neck 452 extended between the engaging stopper 451 and the enlarged mounting end side 44, wherein each of the mounting necks 452 has a cross sectional size smaller than that of the engaging stopper 451 but matching with the size of the corresponding engagement hole 410, such that each of the barrier members 41, 42 is able to be securely mounted to the base surface 11 by inserting the engagement plugs 45 thereof into the engagement holes 410 respectively until the mounting necks 452 are fittingly engaged at the engagement holes 410 respectively, while the engaging stoppers 451 are pressing against an inner surface of the bottom wall of the base body 12 to prevent the barrier members 41, 42 unplugging from the engagement holes 410, and the enlarged mounting end sides 44 are pressing against the base surface 11, so as to not only securely mount the barrier members 41, 42 to the base surface 11, but also provide a liquid sealing effect to prevent any liquid entering the cleaner housing 10 through such engagement holes 410. After engaging the engagement plugs 45 with the engagement holes 410, the barrier members 41, 42 are mounted on the base surface 11 while the free end sides 43 of the barrier members 41, 42 are perpendicularly extended downwards from base surface 11 adjacent to the intake opening 21.

When the pump 31 or the vacuum unit 32 is activated, the liquid on the floor surface 90 within the intaking space 51 is sucked to flow into the intake opening 21 and the free end sides 43 are configured to be curved and bent towards the intake opening 21. As shown in FIG. 7 and FIG. 8, the free end side 43 of each of the barrier members 41, 42 is capable of bending towards the intake opening 21 for a certain degree, while the barrier member 41, 42 is retained to be engaged with the base surface 11 of the base body 12 in position by the sandwich engagement configuration of the engaging stoppers 451 and the mounting end side 44. When the trashes 92 pass through the intaking clearance H1 and reach the intaking space 51, the sandwich engagement configuration of the engagement stoppers 451 and the mounting side end side 44 provides a firm engagement that substantially helps the free end side 43 to be rebounded to its normal perpendicular position with respect to the base surface 11.

Since the barrier members 41, 42 are simply provided at the base surface 11 of the base body 12 to enhance the suction effect of the intake opening 21, the autonomous cleaner has no need to be modified structurally nor any additional component has to be included in the cleaner housing 10.

Furthermore, referring to FIG. 7, the flowing channel 210 is illustrated, through which the liquid is driven to be flowing through the filtering device 20 and the cleaner housing 10 from the intake opening 21 to the discharge opening 22. In order to illustrate the cleaning work of the autonomous cleaner, the trash 92 in the liquid located in front of the cleaning path 91 of the autonomous cleaner is firstly collected by the rotatable brush 17 of the autonomous cleaner to move into the collection space 400 and towards the front barrier member 41. The pump 31 or the vacuum unit 32 generates the suction force and effect in the intaking space 51 and the intake opening 21 to suck in the liquid and the trash 92 therein into the intake opening 21 inside the cleaner housing 10, wherein the flowing of the liquid and trash 92 therein is speed up in the intaking space 51 defined between the barrier members 41, 42 to be sucked into the flowing channel 210 of the filtering device 20. The trash 92 driven to flow into the flowing channel 21 will be collected and retained in the filter container 201 so as to filter out the trash 92 in the liquid and the purified clean liquid will flow out of the filter container 201 through the filtering nets 202 into the receiving cavity 15 and then discharge from discharge outlet 22 of the outlet unit 220 back to the containing environment, such as a swimming pool, water pond or etc., so as to clean the floor surface 90 of the containing environment by the autonomous cleaner of the present invention.

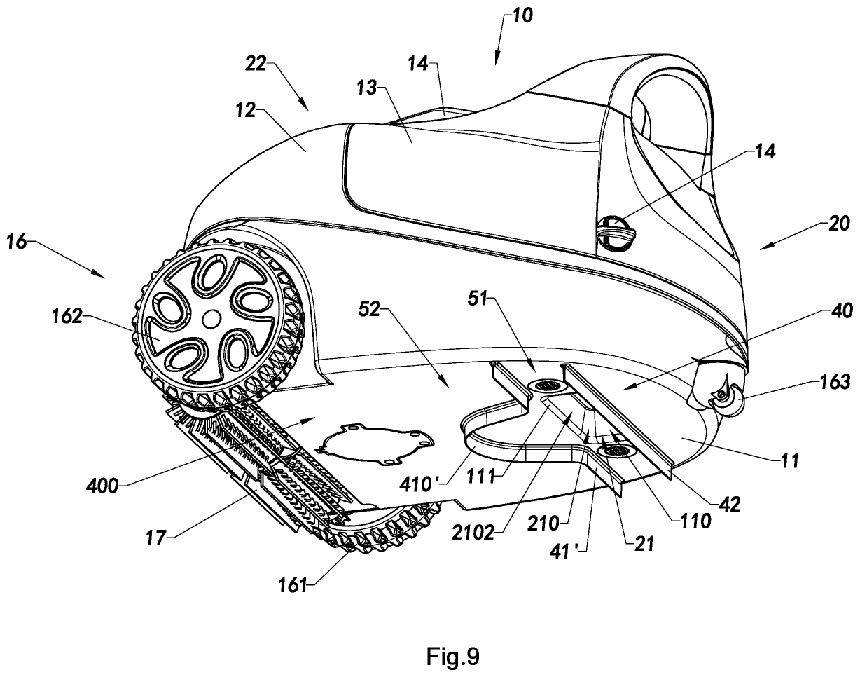

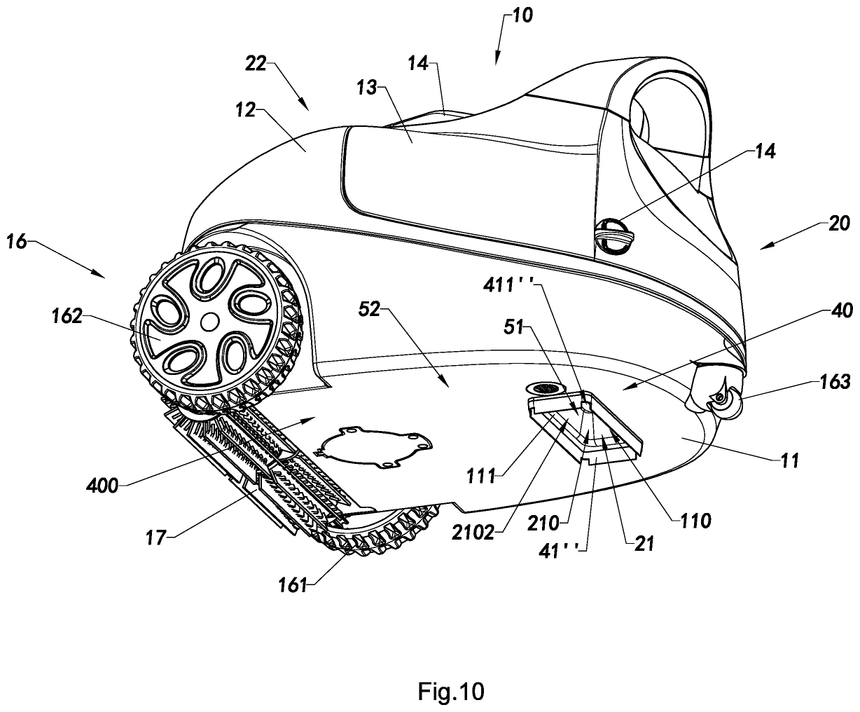

Referring to FIGS. 9 and 10, alternative modes of the barrier member of the autonomous cleaner are illustrated according to a second embodiment and a third embodiment of the autonomous cleaner. According to the second embodiment, the front barrier member 41′ of the suction enhancer arrangement 40 is designed in Ω shape with a middle curvature 410′ so as to enlarge the intaking space 51. According to the third embodiment, the suction enhancer arrangement 40 merely comprises a barrier member 41′ having an endless shape, such as a square or rectangular shape, provided surrounding the intake opening 21. As shown in FIG. 10, the barrier member 41′ is mounted to the base surface 11 in such a manner that four barrier member sides of the barrier member 41′ are mounted adjacent four sides of the inlet opening 110 respectively, wherein four corners of the barrier member 41″ provide four slots 411″ respectively to enable the four barrier member sides of the barrier member 41 being bendable towards the inlet opening 110 (intake opening 21) to let the trash 92 reaching the intaking space 51 defined within the four barrier member sides of the barrier member 41″.

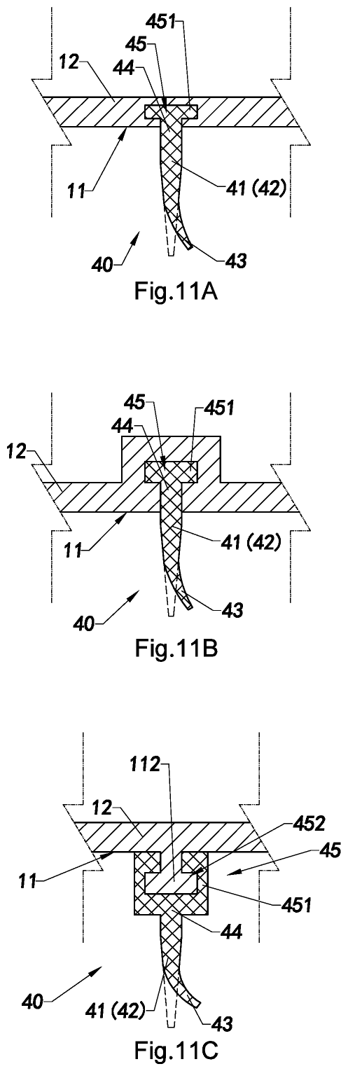

In addition, referring to FIGS. 11A to 11C, alternative modes of the engagement plug are illustrated, wherein the engagement plug 45 thereof simply comprises an engaging stopper 451 formed at and extended along the mounting end side 44 to form a T-shape cross section as shown in FIGS. 11A and 11B, while the engagement plug 45 thereof comprises an engaging stopper 451 which has a T-shape mounting groove 452 therein, as shown in FIG. 11C, adapted for a T-shape mounting member 112 protruded from the base surface 11 to be engaged therein. According to the alternative modes of the engagement of the barrier member(s) 41, 42 with the base surface 11 as shown in FIGS. 11A to 11C, the barrier member 41, 42 is detachably mounted to the base surface 11, such that the barrier member 41, 42 is able to be slidably engaged with the mounting member 112 or detached from base surface 11 for replacement or washing, or for removing the intaking space 51 to reduce of the suction force of the intake opening 21 for particular occasion.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An autonomous cleaner for cleaning away trash on a floor surface under liquid, comprising:
a cleaner housing having a base surface, a receiving cavity therein, an intake opening at said base surface, and a discharge outlet communicated with the receiving cavity and the intake opening;
a moving unit, arranged to the cleaner housing, adapted for moving on the floor surface and supporting the base surface above the floor surface for a predetermined intaking distance;
a power assembly arranged to drive the moving unit to move in a path and provides a suction effect at the intake opening for intaking liquid and trash within a collection space defined between the base surface of the cleaner housing and the floor surface where the cleaner housing moving thereon with a flow of liquid;
a filtering device installed in the receiving cavity of the cleaner housing, such that the trash in the liquid sucked through the intake opening is filtered and collected by the filtering device and discharged from the discharge outlet; and
a suction enhancer arrangement provided adjacent to the intake opening of the cleaner housing to define an intaking space between the intake opening and the floor surface, such that the flow of liquid to be sucked into the intake opening is speed up in the intaking space to enhance the suction effect.

2. The autonomous cleaner, as recited in claim 1, wherein the suction enhancer arrangement comprises at least one barrier member provided adjacent to the intake opening and protruded from the base surface with a width smaller than the predetermined intaking distance defined between the base surface and the floor surface where the cleaner housing being driven to move thereon in such a manner that an intaking clearance is formed between a free end side of the barrier member and the floor surface where the cleaner housing moving thereon, wherein the intaking space includes at least a space between the intake opening and the barrier member, such that the at least one barrier member divides the collection space into the intaking space between the intake opening and the least one barrier member and an outer space surrounding the at least one barrier member, so that the flow of liquid having a first flowing speed is produced in the collection space according to the suction effect generated for driving the liquid and any trash therein to flow into the intake opening, and that the flow of liquid is speed up while passing the intaking clearance that increases the suction force within the intaking space to suck the liquid and any trash in the intaking space to flow into the intake opening with a second flowing speed which is faster than the first flowing speed.

3. The autonomous cleaner, as recited in claim 1, wherein the suction enhancer arrangement comprises at least two barrier members provided adjacent to the intake opening, wherein the at least two barrier members are positioned and extended between two side portions of the base surface of the cleaner housing and the intake opening is positioned between the at least two barrier members, defining a space below the base surface and between the at least two barrier members as the intaking space, wherein each of the at least two barrier members is protruded from the base surface with a width smaller than the predetermined intaking distance defined between the base surface and the floor surface where the cleaner housing being driven to move thereon in such a manner that an intaking clearance is formed between a free end side of each of the at least two barrier members and the floor surface where the cleaner housing moving thereon, wherein the intaking space includes at least a space between the at least two barrier members, such that the at least two barrier members divides the collection space into the intaking space between the at least two barrier members and an outer space surrounding the at least two barrier members, so that the flow of liquid having a first flowing speed is produced in the collection space according to the suction effect generated for driving the liquid and any trash therein to flow into the intake opening between the at least two barrier members, and that the flow of liquid is speed up while passing the intaking clearance that increases the suction force within the intaking space to suck the liquid and any trash in the intaking space to flow into the intake opening with a second flowing speed which is faster than the first flowing speed.

4. The autonomous cleaner, as recited in claim 1, wherein the suction enhancer arrangement comprises an endless barrier member provided surrounding the intake opening and protruded from the base surface with a width smaller than the predetermined intaking distance defined between the base surface and the floor surface where the cleaner housing being driven to move thereon in such a manner that an intaking clearance is formed between a free end side of the barrier member and the floor surface where the cleaner housing moving thereon, wherein the intaking space includes at least a space surrounded by the barrier member, such that the barrier member divides the collection space into the intaking sp ace within the barrier member and an outer space outside the barrier member, so that the flow of liquid having a first flowing speed is produced in the collection space according to the suction effect generated for driving the liquid and any trash therein to flow into the intake opening, and that the flow of liquid is speed up while passing the intaking clearance that increases the suction force within the intaking space to suck the liquid and any trash in the intaking space to flow into the intake opening with a second flowing speed which is faster than the first flowing speed.

5. The autonomous cleaner, as recited in claim 2, wherein the moving unit comprises at least two wheels rotatably mounted to both sides of the cleaner housing respectively and being driven by the power assembly to rotate for moving the cleaner housing on the floor surface while the base surface is supported by the wheels above the floor surface, wherein a portion of each of the wheels is extended below the base surface to define the predetermined intaking distance between the base surface and the floor surface.

6. The autonomous cleaner, as recited in claim 3, wherein the moving unit comprises at least two wheels rotatably mounted to both sides of the cleaner housing respectively and being driven by the power assembly to rotate for moving the cleaner housing on the floor surface while the base surface is supported by the wheels above the floor surface, wherein a portion of each of the wheels is extended below the base surface to define the predetermined intaking distance between the base surface and the floor surface.

7. The autonomous cleaner, as recited in claim 4, wherein the moving unit comprises at least two wheels rotatably mounted to both sides of the cleaner housing respectively and being driven by the power assembly to rotate for moving the cleaner housing on the floor surface while the base surface is supported by the wheels above the floor surface, wherein a portion of each of the wheels is extended below the base surface to define the predetermined intaking distance between the base surface and the floor surface.

8. The autonomous cleaner, as recited in claim 2, wherein the at least one barrier member is made of elastic material and has the free end side downwardly protruded from the base surface and a mounting end side configured to be mounted on the base surface, such that the at least one barrier member is positioned and extended between two side portions of the base surface of the cleaner housing, wherein the at least one barrier member is able to bend towards the base surface while a pushing force is exerted on the at least one barrier member towards the intake opening.

9. The autonomous cleaner, as recited in claim 3, wherein each of the two barrier members has the free end side downwardly protruded from the base surface and a mounting end side configured to be mounted on the base surface, wherein one of the at least two barrier members, which is positioned in front of the intake opening and extended between the two side portions of the base surface, is made of elastic material that is able to bend towards the base surface while a pushing force is exerted on the barrier member towards the intake opening.

10. The autonomous cleaner, as recited in claim 4, wherein the barrier member is made of elastic material and has the free end side downwardly protruded from the base surface and a mounting end side configured to be mounted on the base surface, wherein the barrier member is able to bend towards the base surface while a pushing force is exerted on the barrier member towards the intake opening.

11. The autonomous cleaner, as recited in claim 8, wherein an inlet opening is formed in the base surface and connected with the intake opening, wherein engagement holes are formed along one side of the inlet opening, wherein the at least one barrier member further comprises a plurality of engagement plugs provided at the mounting end side thereof and configured to be inserted into the engagement holes respectively, wherein each of the engagement plugs comprises at least an engaging stopper and a mounting neck between the engaging stopper and the mounting end side, wherein each of the mounting necks has a cross sectional size smaller than that of the engaging stopper but matching with a size of the corresponding engagement hole, such that the at least one barrier member is able to be securely mounted to the base surface by inserting the engagement plugs thereof into the engagement holes respectively until the mounting necks are fittingly engaged at the engagement holes respectively, while the engaging stoppers are pressing against an inner surface of a bottom wall of the base body and the mounting end sides are pressing against the base surface.

12. The autonomous cleaner, as recited in claim 9, wherein an inlet opening is formed in the base surface and connected with the intake opening, wherein engagement holes are formed along a front side and a rear side of the inlet opening, wherein each of the at least two barrier members further comprises a plurality of engagement plugs provided at the mounting end side thereof and configured to be inserted into the engagement holes respectively, wherein each of the engagement plugs comprises at least an engaging stopper and a mounting neck between the engaging stoppers and the mounting end side, wherein each of the mounting necks has cross sectional size smaller than that of the engaging stopper but matching with a size of the corresponding engagement hole, such that each of the at least two barrier members is able to be securely mounted to the base surface by inserting the engagement plugs thereof into the corresponding engagement holes until the mounting necks are fittingly engaged at the engagement holes respectively, while the engaging stoppers are pressing against an inner surface of a bottom wall of the base body and the mounting end sides are pressing against the base surface.

13. The autonomous cleaner, as recited in claim 10, wherein an inlet opening is formed in the base surface and connected with the intake opening, wherein engagement holes are formed around the inlet opening, wherein the barrier member further comprises a plurality of engagement plugs provided at the mounting end side thereof and configured to be inserted into the engagement holes respectively, wherein each of the engagement plugs comprises at least an engaging stopper and a mounting neck between the engaging stopper and the mounting end side, wherein each of the mounting necks has a cross sectional size smaller than that of the engaging stopper but matching with a size of the corresponding engagement hole, such that the barrier member is able to be securely mounted to the base surface by inserting the engagement plugs thereof into the engagement holes respectively until the mounting necks are fittingly engaged at the engagement holes respectively, while the engaging stoppers are pressing against an inner surface of a bottom wall of the base body and the mounting end sides are pressing against the base surface.

14. A suction enhancer arrangement for an autonomous cleaner which comprises a cleaner housing having a base surface and an intake opening provided on the base surface, a moving unit arranged to the cleaner housing, a power assembly arranged to drive the moving unit to move on a floor surface of a containing environment and provide a suction force at a collection space defined around the intake opening, and a filtering device arranged in the cleaner housing for filtering and collecting trash in a liquid of the containing environment sucked in through the intake opening before discharging the filtered liquid back to the containing environment through the discharge outlet, wherein the suction enhancer arrangement is provided adjacent to the intake opening of the cleaner housing to define an intaking space between the intake opening and the floor surface where the cleaner housing moving thereon, such that a flow of the liquid to be sucked into the intake opening is speed up in the intaking space to enhance a suction effect thereat.

15. The suction enhancer arrangement, as recited in claim 14, comprising at least one barrier member configured for being provided adjacent to the intake opening and protruded from the base surface with a width smaller than the predetermined intaking distance defined between the base surface and the floor surface where the cleaner housing being driven to move thereon, wherein the at least one barrier member has a free end side defining an intaking clearance therefrom with the floor surface where the cleaner housing moving thereon, wherein the intaking space includes at least a space between the intake opening and the barrier member, such that the at least one barrier member divides the collection space into the intaking space between the intake opening and the least one barrier member and an outer space surrounding the at least one barrier member, so that the flow of liquid having a first flowing speed is produced in the collection space according to the suction effect generated for driving the liquid and any trash therein to flow into the intake opening, and that the flow of liquid is speed up while passing the intaking clearance that increases the suction force within the intaking space to suck the liquid and any trash in the intaking space to flow into the intake opening with a second flowing speed which is faster than the first flowing speed.

16. The suction enhancer arrangement, as recited in claim 14, comprising at least two barrier members configured for being provided adjacent to the intake opening, wherein the at least two barrier members are arranged for being positioned and extended between two side portions of the base surface of the cleaner housing and the intake opening is positioned between the at least two barrier members, defining a space below the base surface and between the at least two barrier members as the intaking space, wherein each of the at least two barrier members is configured for being protruded from the base surface with a width smaller than the predetermined intaking distance defined between the base surface and the floor surface where the cleaner housing being driven to move thereon, wherein each of the at least two barrier members has a free end side defining an intaking clearance therefrom with the floor surface where the cleaner housing moving thereon, wherein the intaking space includes at least a space between the at least two barrier members, such that the at least two barrier members divides the collection space into the intaking space between the at least two barrier members and an outer space surrounding the at least two barrier members, so that the flow of liquid having a first flowing speed is produced in the collection space according to the suction effect generated for driving the liquid and any trash therein to flow into the intake opening between the at least two barrier members, and that the flow of liquid is speed up while passing the intaking clearance that increases a suction force within the intaking space to suck the liquid and any trash in the intaking space to flow into the intake opening with a second flowing speed which is faster than the first flowing speed.

17. The suction enhancer arrangement, as recited in claim 14, comprising an endless barrier member configured for being provided surrounding the intake opening and protruded from the base surface with a width smaller than the predetermined intaking distance defined between the base surface and the floor surface where the cleaner housing being driven to move thereon, wherein the barrier member has a free end side defining an intaking clearance therefrom with the floor surface where the cleaner housing moving thereon, wherein the intaking space includes at least a space surrounded by the barrier member, such that the barrier member divides the collection space into the intaking space within the barrier member and an outer space outside the barrier member, so that the flow of liquid having a first flowing speed is produced in the collection space according to the suction effect generated for driving the liquid and any trash therein to flow into the intake opening, and that the flow of liquid is speed up while passing the intaking clearance that increases the suction force within the intaking space to suck the liquid and any trash in the intaking space to flow into the intake opening with a second flowing speed which is faster than the first flowing speed.

18. The suction enhancer arrangement, as recited in claim 15, wherein the at least one barrier member is made of elastic material and has a mounting end side configured for being mounted on the base surface while the free end side thereof being downwardly protruded from the base surface, such that the at least one barrier member is arranged for being positioned and extended between two side portions of the base surface of the cleaner housing, wherein the at least one barrier member is configured capable of bending towards the base surface while a pushing force is exerted on the at least one barrier member towards the intake opening.

19. The suction enhancer arrangement, as recited in claim 16, wherein each of the two barrier members has a mounting end side configured for being mounted on the base surface while the free end side thereof being downwardly protruded from the base surface, wherein one of the at least two barrier members, which is adapted to be positioned in front of the intake opening and extended between the two side portions of the base surface, is made of elastic material that is configured capable of bending towards the base surface while a pushing force is exerted on the barrier member towards the intake opening.

20. The suction enhancer arrangement, as recited in claim 17, wherein the barrier member is made of elastic material and has a mounting end side configured for being mounted on the base surface while the free end side thereof being downwardly protruded from the base surface, wherein the barrier member is configured capable of bending towards the base surface while a pushing force is exerted on the barrier member towards the intake opening.

21. A suction enhancer arrangement for mounting adjacent to an intake opening provided on a base surface of an autonomous cleaner, comprises at least two barrier members each having a mounting end side configured for being mounted to the base surface and a free end side adapted for downwardly extended from the base surface, wherein the at least two barrier members are made of elastic material and arranged for being positioned and extended between two side portions of the base surface and the intake opening is positioned between the at least two barrier members, defining a space below the base surface and between the at least two barrier members as an intaking space, such that a flow of liquid to be sucked into the intake opening is speed up in the intaking space to enhance a suction effect thereat.

22. The suction enhancer arrangement, as recited in claim 21, wherein each of the at least two barrier members is configured for being protruded from the base surface with a width smaller than a predetermined intaking distance defined between the base surface and a floor surface where the autonomous cleaner being driven to move thereon, wherein an intaking clearance is defined between the free end side of each of the at least two barrier members and a floor surface where the autonomous cleaner moving thereon, wherein the intaking space includes at least a space between the at least two barrier members, such that the at least two barrier members are configured for dividing a collection space defined between the base surface and the floor surface where the autonomous cleaner moving thereon into the intaking space between the at least two barrier members and an outer space surrounding the at least two barrier members, so that the flow of liquid having a first flowing speed is produced in the collection space according to the suction effect generated for driving a liquid and any trash therein to flow into the intake opening between the at least two barrier members, and that the flow of liquid is speed up while passing the intaking clearance that increases a suction force within the intaking space to suck the liquid and any trash in the intaking space to flow into the intake opening with a second flowing speed which is faster than the first flowing speed.

23. The suction enhancer arrangement, as recited in claim 22, wherein each of the at least two barrier members comprises a plurality of engagement plugs provided at the mounting end side thereof and configured for being inserted into engagement holes formed in the base surface respectively, wherein each of the engagement plugs comprises at least an engaging stopper and a mounting neck between the engaging stopper and the mounting end side, wherein each of the mounting necks has a cross sectional size smaller than that of the engaging stopper but matching with a size of the corresponding engagement hole, such that the at least two barrier members are arranged for being securely mounted to the base surface by inserting the engagement plugs thereof into the engagement holes respectively until the mounting necks are fittingly engaged at the engagement holes respectively, while the engaging stoppers and the mounting end sides are sandwiching the base surface.
